(19) United States
(12) Patent Application Publication
(10) Pub. No.: US 2018/0116170 A1
(43) Pub. Date: May 3, 2018

(54) ROBO PET-SITTER

(71) Applicant: Dharmesh Joshi, Plainsboro, NJ (US)

(72) Inventor: Dharmesh Joshi, Plainsboro, NJ (US)

(21) Appl. No.: 15/799,725

(22) Filed: Oct. 31, 2017

Related U.S. Application Data
(60) Provisional application No. 62/415,364, filed on Oct. 31, 2016.

(51) Int. Cl. A01K 1/035; A01K 15/02; A01K 11/00; A01K 7/02; A01K 5/02; A01K 1/01; A01K 29/00; A01K 39/04; H04N 7/14

(52) U.S. Cl. CPC A01K 1/035; A01K 15/026; A01K 11/006; A01K 7/02; H04W 4/008; A01K 1/0107; A01K 29/005; A01K 39/04; H04N 7/142; A01K 5/02

(57) ABSTRACT

An automated system for meeting the needs of cats, dogs, and possibly birds, for up to three or four weeks, while the owners are away structured and arranged to provide food, water, various activities, and human contact via the Internet.

### CROSS-REFERENCE TO RELATED APPLICATION

The present application is related to and claims priority from prior provisional application Ser. No. 62/415,364, filed Oct. 31, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of communication devices and more specifically relates to a pet servicing device to meet the needs of cats, dogs, and possibly birds, for up to three or four weeks, while the owners are away structured and arranged to provide food, water, various activities, and human contact via the Internet.

### 2. Description of the Related Art

In the United States, 63% of the households include pets, and the proportion of households with pets is larger than those with children. A pet or companion animal is an animal kept primarily for a person's company, protection, or entertainment rather than as a working animal, livestock, or laboratory animal. Popular pets are often noted for their attractive appearances, and their loyal or playful personalities.

Pets provide their owners physical and emotional benefits. Walking a dog can supply both the human and pet with exercise, fresh air, and social interaction. Pets can give companionship to elderly adults who do not have adequate social interaction with other people, as well as to other people who are living alone. There is a medically approved class of therapy animals, mostly dogs or cats, that are brought to visit confined humans, such as children in hospitals or elders in nursing homes. Pet therapy utilizes trained animals and handlers to achieve specific physical, social, cognitive, and emotional goals with patients.

As responsible pet owners, we provide our pets with shelter and care. In return, they give us unrestricted love and attention. While away, pet owners need a way to provide for their pet's needs when they are away on vacation. Pet owners do not always trust pet sitters and hates the idea of their pet being enclosed in a tiny cage at a pet hotel while they are away. Therefore, a need exists for a specially designed way to provide food, water, and human contact while also monitoring their activity and keeping them busy while their owners are gone.

Various attempts have been made to solve problems found in communication device art. Among these are found in: U.S. Pat. No. 9,226,477 to Andrew Peter Davis; U.S. Publication No. 9737049 to Trotier et al.; U.S. Pat. No. 20040194714 to Ji-hong Lee; U.S. Pat. No. 20110139076 to Pu et al; and U.S. Pat. No. 5,299,529 to Peter Ramirez This prior art is representative of communication and/or automatic feeding devices for pets while they are alone.

Ideally, a pet servicing should be user-friendly and safe in-use and, yet should operate reliably and be manufactured at a modest expense. Thus, a need exists for a pet servicing device to meet the needs of cats, dogs, and possibly birds, for up to three or four weeks, while the owners are away structured and arranged to provide food, water, various activities, and human contact via the Internet and to avoid the above-mentioned problems.

### BRIEF SUMMARY OF THE INVENTION

In view of the foregoing disadvantages inherent in the known communication device art, the present invention provides a Pet Servicing Device (entitled Robo Pet-Sitter). The general purpose of the present invention, which will be described subsequently in greater detail is to provide a pet servicing device to meet the needs of cats, dogs, and possibly birds, for up to three or four weeks, while the owners are away structured and arranged to provide food, water, various activities, and human contact via the Internet.

A pet servicing device comprising: a base station; a plurality of modules; and a control panel. The base station includes a base portion and an elongated spindle member. The base portion includes an outer wall and an interior volume defined by the outer wall, and a power source. The base portion is adapted to be securely placed on a supporting surface. The power source is located within the interior volume and is adapted to provide power thereto. The power member is located within and along the elongated interior volume, is connected to the power source of the base station and is adapted to provide power along and through the outer wall and into modules placed thereon. The elongated spindle member including an outer wall and an elongated interior volume defined by the outer wall, and a power member. The spindle member is connected at a proximal end to the base portion and extends upwardly therefrom.

The plurality of modules, each comprising: a body portion, a power member, and at least one mechanical device. The body portion includes an outer wall and an interior volume defined by the outer wall, an aperture, and at least one opening. The aperture is formed on the outer wall and is adapted to allow the spindle member to pass therethrough, such that the module is adapted to be placed removably and securely upon the base station.

The at least one opening is formed on an outer edge of the outer wall. The power member is located within the interior volume and is adapted to receive power from the power member of the spindle member. The at least one mechanical device is located within the interior volume of the body portion and adjacent to one of the at least one opening, is electrically connected to the power member, the receiver member, and the transmitter member, and is adapted to provide a chosen mechanical function.

The control panel includes an interior volume, a power member, a receiver member, a transmitter member, a computer member, a front surface, and a plurality of control members. The power member is located within the interior volume and is adapted to receive power from the power member of the base station. The receiver member is located within the interior volume, is connected to the power member, and is adapted to receive electronic signals from an external source. The transmitter member is located within the interior volume, is connected to the power member, and is adapted to send electronic signals to the external source. The computer member is located within the interior volume, is electrically connected to the receiver member and the transmitter member, is adapted to receive power from the power member, and is adapted to send electronic signals to each said mechanical device of each of the plurality of modules. The plurality of control members are located upon the front surface and are electrically connected to the power member and the computer member. The control panel is adapted to be electronically and releasably attached to said base station and control the functions of the base station, and each of the plurality of modules.

The present invention holds significant improvements and serves as a Pet Servicing Device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Pet Servicing Device (entitled Robo Pet-Sitter), constructed and operative according to the teachings of the present invention.

FIG. 1A shows a perspective view illustrating a pet servicing device according to an embodiment of the present invention.

FIG. 1B shows a perspective view illustrating a disc member being thrown by a disc thrower to a dog in a first in-use condition of pet servicing device according to an embodiment of the present invention.

FIG. 1C shows a perspective view illustrating a ball member being thrown by a ball thrower to a dog in a second in-use condition of pet servicing device according to an embodiment of the present invention.

FIG. 2 shows a perspective view illustrating an elongated spindle member on a base station of the pet servicing device according to an embodiment of the present invention.

FIG. 3 shows a perspective view illustrating a motor member on the mechanical device of the pet servicing device according to an embodiment of the present invention.

FIG. 4 shows a perspective view illustrating a control panel of the pet servicing device according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a communication device and more specifically relates to a Pet Servicing Device (entitled Robo Pet-Sitter) to meet the needs of cats, dogs, and possibly birds, for up to three or four weeks, while the owners are away structured and arranged to provide food, water, various activities, and human contact via the Internet

Generally speaking, the Robo-PetSitter is designed to meet the physical and emotional needs of pets when owners are away for long periods of time. It is operated by a base station, which is the same size as a medium-sized paper shredder. It has built-in Wi-Fi and two to four USB ports and a power cord. The base station has cameras on all four sides, a mike and speakers, which emit high-frequency sounds that can be heard by dogs and cats. Using Wi-Fi and Bluetooth's functionality, owners will be able to observe the activities of their pet and to communicate with their pets while they are away. Use the existing micro chip technology or microchip collar for pets that can help identify the pets when they are near the base station or locate them in the home. This is needed in case of multiple pets in a home and keep a track of their whereabouts. There is a drone with a camera sitting on top of one of base stations that can fly when triggered by owners or regular intervals or when a particular pet has not checked-in to ensure their safety and contact owners as necessary. This drone flies autonomously using existing drone technology available and self-flying drone technology available in market such as drone hardware and software. If there is a need then few changes can be done to existing software to accommodate the needs of the Robo-PetSitter

Pets will be able to see their owners on the display screen, when owners use the camera on their smart phones when talking with their pets. There are many extra devices that can be added to the base station, depending on what is needed for individual pets. These are controlled through the owner's smart phone and are aligned on a spindle attached to the base station. There are separate, self-cleaning and self-filling food and water bowls, with extra storage capacity for up to three weeks of food and clean water. The toilet needs for pets are met by self-cleaning and self-packing modules, which can be sealed to prevent leakage and have cleanliness and hygiene in home while owners are away. The technology used here is same as one used in Space by astronauts. I am not sure how that works but it is possible to use it.

There are also modules that can throw a Frisbee or a ball for dogs, and activate toys for cats to chase, which can avoid obstacles as well as cats. A drone and a laser pointer can be used to tease and to play with a cat as well. These extra devices are controlled via the owner's smart phone. The detachable components revolve around the spindle. Each consists of two sections. The inner section is black, and the outer one can be any other color. The inner ones sit on top of each other in a particular way, and there is no other way possible using the dowels. The outer one revolves around the inner one, so the owner can control the direction the ball or Frisbee as it is thrown and also control the positions of the other modules. The section with the screen, camera and speaker also revolves around the spindle. Since one base station can hold and operate up to four extra modules or devices, owners may wish to purchase more than one base station, which can be linked to the others via Wi-Fi. One base station can be set apart and used as a restroom, so pets can relieve themselves without being too close to their food and water.

The unique features of this product will provide the following benefits for consumers everywhere:
A convenient way to provide pets needs when owners are away for extensive periods of time
Pets will be comforted by seeing their owners and hearing their voices when their owners communicate using their smart phones
Owners will be able to monitor the activities of their pets using multiple cameras attached to the device
Basic needs, like food, water and toilet, can be met for up to four weeks
Various activity modules can be included to keep pets entertained and occupied
Treat dispensers are incorporated into the activity modules, in order to facilitate training the pets to use the devices
Using multiple base stations, which are linked to each other via Wi-Fi, will make the activities more fun for the pets
Multiple devices may be spread around a home or across the property, so the pet has freedom to roam, and they can be controlled automatically using Wi-Fi or manually
These extra devices can operate by themselves when mounted on walls or cabinets, but would not be connected to Wi-Fi and Bluetooth as they are when stacked base station's spindle
Use of the Robo-PetSitter will eliminate the need to use pet sitters or pet hotels and allow owners to interact and care for their pets when they are traveling

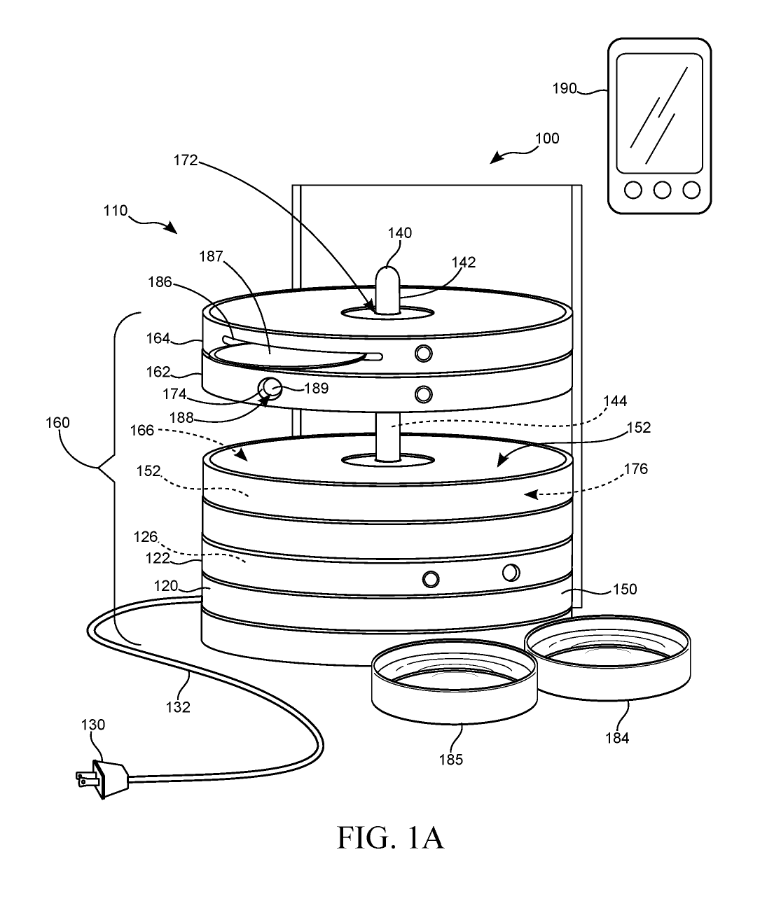

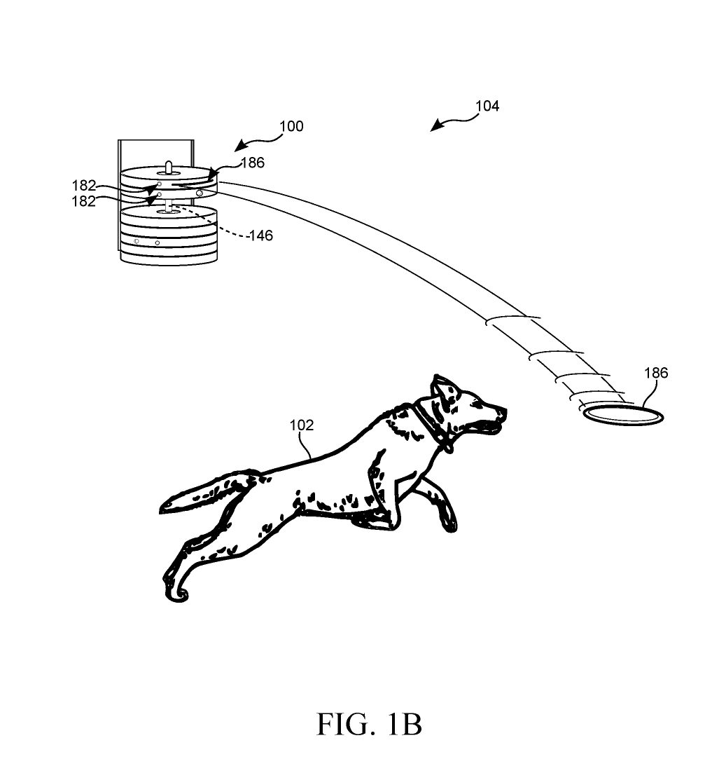

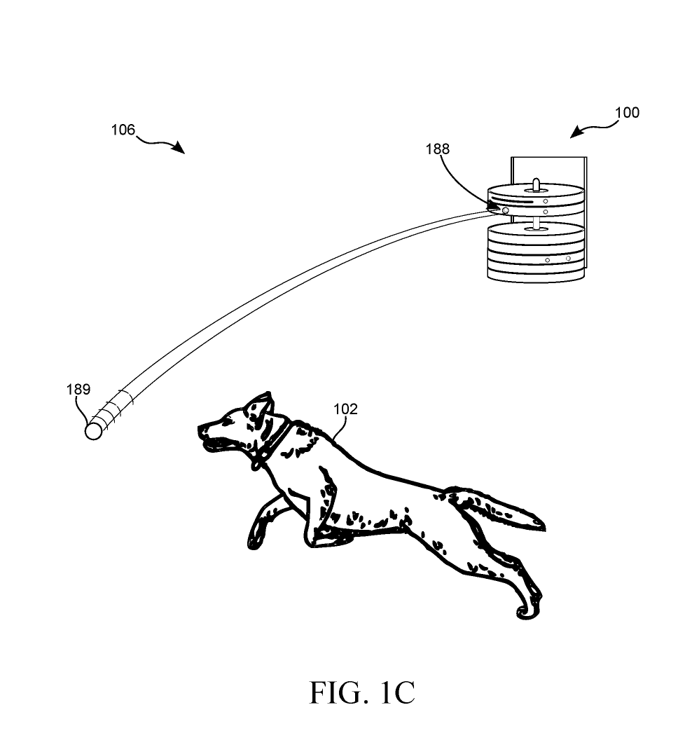

Referring now to FIGS. 1-4 showing perspective views illustrating pet servicing device 100 according to an embodiment of the present invention of FIG. 1.

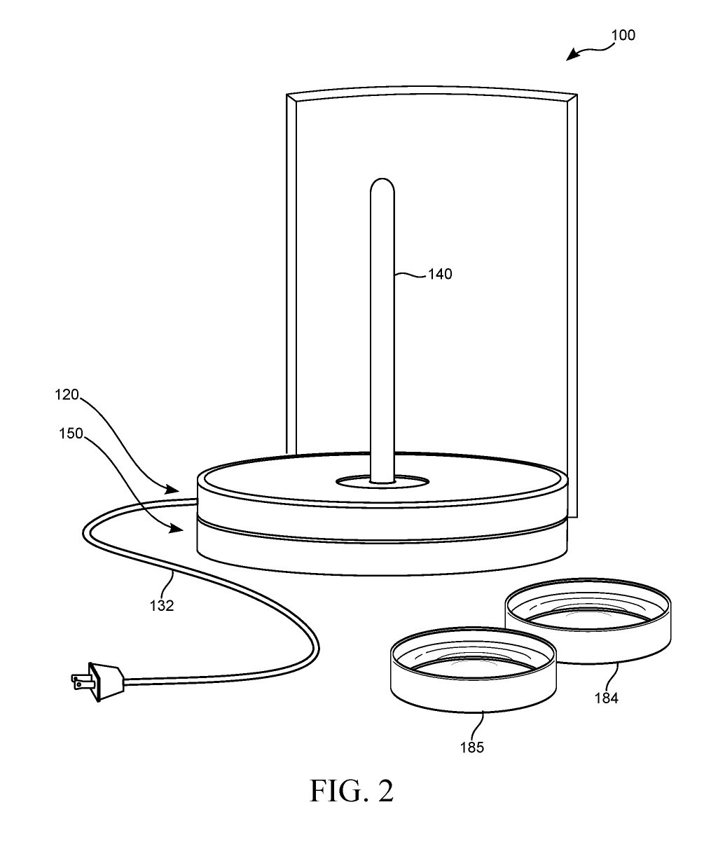

Pet servicing device 100 comprising: base station 110; plurality of modules 150; and control panel 400. Base station 110 includes base portion 120 and elongated spindle member 140. Base portion 120 includes outer wall 122 and interior volume 126 defined by outer wall 122, and power source 130. Base portion 120 is adapted to be securely placed on a supporting surface. Power source 130 is located within interior volume 126 and is adapted to provide power thereto. Power source 130 is formed as power cord 132 adapted to be plugged into an external power source as shown in FIG. 1. Elongated spindle member 140 including outer wall 142 and elongated interior volume 144 defined by outer wall 142, and power member 146 as shown in FIG. 2. Power member 146 is located within and along elongated interior volume 144, is connected to power source 130 of base station 110 and is adapted to provide power along and through outer wall 142 and into modules 150 placed thereon. Spindle member 140 is connected at a proximal end to base portion 120 and extends upwardly therefrom.

Plurality of modules 150, each comprising: body portion 160, power member 176, and at least one mechanical device 180. Body portion 160 includes outer wall 162 and interior volume 166 defined by outer wall 168, aperture 172, and at least one opening 174. Aperture 172 is formed on outer wall 168 and is adapted to allow spindle member 140 to pass therethrough, such that module 150 is adapted to be placed removably and securely upon base station 110 as shown in FIG. 2. At least one opening 174 is formed on outer edge 164 of outer wall 162. Power member 176 is located within interior volume 126 and is adapted to receive power from power member 146 of spindle member 140. Wherein one of plurality of modules 150 is formed as storage chamber 152. Base portion 120 and plurality of modules 150 are disc-shaped

At least one mechanical device 180 is located within interior volume 126 of body portion 160 and adjacent to one of the at least one opening 174, is electrically connected to power member 170, receiver member 430, and transmitter member 440, and is adapted to provide a chosen mechanical function.

Wherein at least one mechanical device 180 is treat dispenser 182 as shown in FIG. 1. Wherein at least one mechanical device 180 includes food bowl 184 and water bowl 185 also shown in FIG. 1. Food bowl 184 may include both wet pet food and dry pet food depending on the type of diet a pet is on.

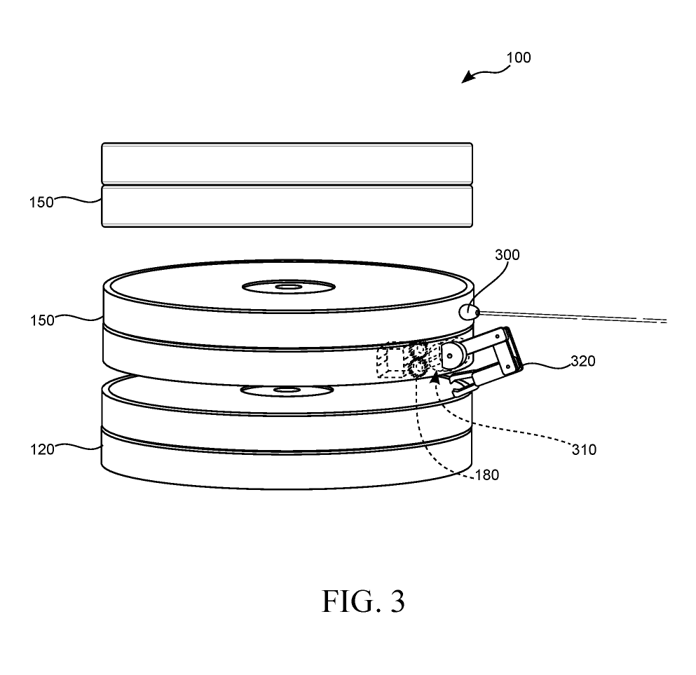

Control panel 400 is adapted to be electronically and releasably attached to base station 110 and control the functions of base station 110, and each of plurality of modules 150. Wherein each of plurality of modules 150 includes motor member 310 therein electrically connected to a respective power member 420 and are adapted to allow computer member 450 of control panel 400 to rotate each of plurality of modules 150 to a chosen position. Control panel 400 is formed having an arcuate cross-section adapted to partially wrap around adjacent outer edges of plurality of modules 150 when located upon said elongated spindle member 140.

Wherein at least one mechanical device 180 includes laser pointer 300; and wherein one of plurality of modules 150 includes motor member 310 therein electrically connected to power member 176 and adapted to allow computer member 450 of control panel 400 to rotate one of plurality of modules 150 to a chosen position to point laser pointer 300. Wherein at least one mechanical device 180 robotic arm 320 also shown in FIG. 3; and wherein one of plurality of modules 150 includes motor member 310 therein electrically connected to power member 176 and adapted to allow computer member 450 of control panel 400 to rotate one of plurality of modules 150 to a chosen position to operate robotic arm 320.

Pet servicing device 100 further comprising disc member 187 adapted to be bit and chewed by animal 102; wherein mechanical device 180 of one of plurality of modules 150 is formed as disc thrower 186 as shown in first in-use condition 104 of FIG. 1B; and wherein one of plurality of modules 150 includes motor member 310 therein electrically connected to power member 176 and adapted to allow computer member 450 of control panel 400 to rotate one of plurality of modules 150 to a chosen position to throw disc member 187 as shown in FIG. 1B. Pet servicing device 100 further comprising ball member 189 adapted to be bit and chewed by animal 102 as shown in second in-use condition 106 of FIG. 1C; wherein mechanical device 180 of one of plurality of modules 150 is formed as ball thrower 188; and wherein one of plurality of modules 150 includes motor member 310 therein electrically connected to power member 176 and adapted to allow computer member 450 of control panel 400 to rotate one of plurality of modules 150 to a chosen position to throw said ball member.

Control panel 400 includes interior volume 410, power member 420, receiver member 430, transmitter member 440, computer member 450, front surface 460, and plurality of control members 490. Power member 420 is located within interior volume 410 and is adapted to receive power from power member 146 of base station 110. Receiver member 430 is located within interior volume 410, is connected to power member 420, and is adapted to receive electronic signals from an external source. Receiver member 420 and transmitter member 430 of control panel 400 incorporates BLUETOOTH technology 424. Transmitter member 440 is located within interior volume 410, is connected to power member 420, and is adapted to send electronic signals to the external source. Pet servicing device 100 further comprising external device 190 adapted to communicate with receiver member 430 and transmitter member 440 of control panel 400, and adapted to control pet servicing device 100. External device 190 is formed as a smart phone.

Computer member 450 is located within interior volume 410, is electrically connected to receiver member 430 and transmitter member 440, is adapted to receive power from power member 420, and is adapted to send electronic signals to each mechanical device 180 of each of plurality of modules 150. Plurality of control members 490 are located upon front surface 460 and are electrically connected to power member 420 and computer member 450.

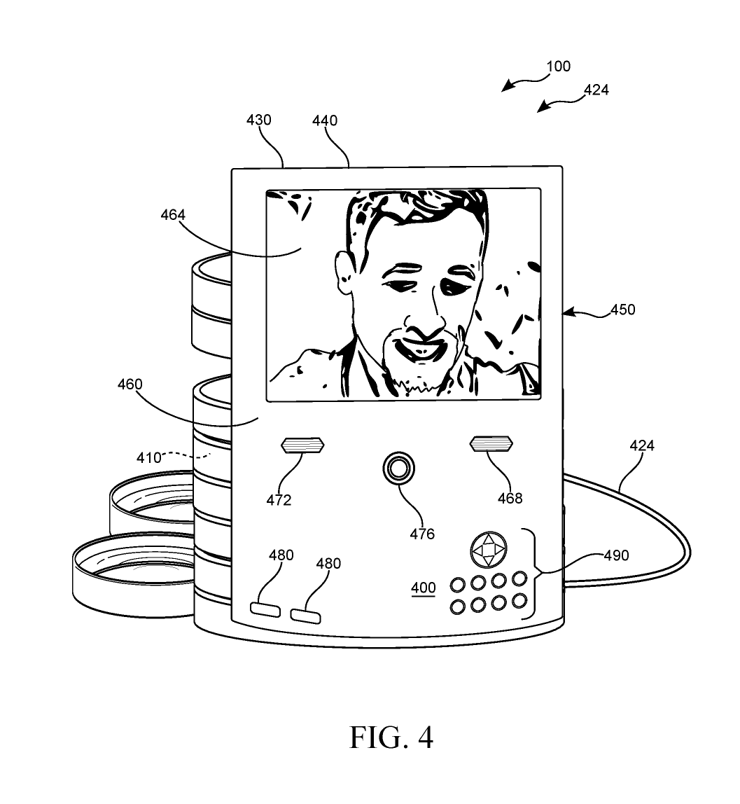

Front surface 460 of control panel 400 further includes video screen 464 connected thereto electrically connected to power member 420 and computer member 450 as shown in FIG. 4. Front surface 460 of control panel 400 further includes at least one speaker member 468 connected thereto electrically connected to power member 420 and computer member 450. Speaker member 468 is adapted to emit high-frequency sounds adapted to attract the attention of animal 102.

Front surface 460 of control panel 400 further includes at least one microphone member 472 connected thereto electrically connected to power member 420 and computer member 450. Front surface 460 of control panel 400 further includes at least one camera member 476 connected thereto electrically connected to power member 420 and computer member 450. Front surface 460 of control panel 400 further includes at least one USB connector port 480 connected thereto electrically connected to power member 420 and computer member 450.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A pet servicing device comprising:
a base station including:
a base portion including:
an outer wall; and
an interior volume defined by said outer wall; and
a power source;
wherein said power source is located within said interior volume and is adapted to provide power thereto; and
wherein said base portion is adapted to be securely placed on a supporting surface; and
an elongated spindle member including:
an outer wall; and
an elongated interior volume defined by said outer wall; and
a power member;
wherein said power member is located within and along said elongated interior volume, is connected to said power source of said base station and is adapted to provide power along and through said outer wall and into modules placed thereon; and
wherein said spindle member is connected at a proximal end to said base portion and extends upwardly therefrom;
a plurality of modules, each comprising:
a body portion including:
an outer wall; and
an interior volume defined by said outer wall; and
an aperture;
wherein said aperture is formed on said outer wall and is adapted to allow said spindle member to pass therethrough, such that said module is adapted to be placed removably and securely upon said base station;
and
at least one opening;
wherein said at least one opening is formed on an outer edge of said outer wall;
a power member;
wherein said power member is located within said interior volume and is adapted to receive power from said power member of said spindle member; and
at least one mechanical device;
wherein said at least one mechanical device is located within said interior volume of said body portion and adjacent to one of said at least one opening, is electrically connected to said power member, said receiver member, and said transmitter member, and is adapted to provide a chosen mechanical function; and
a control panel including:
an interior volume;
a power member;
wherein said power member is located within said interior volume and is adapted to receive power from said power member of said base station;
a receiver member;
wherein said receiver member is located within said interior volume, is connected to said power member, and is adapted to receive electronic signals from an external source;
a transmitter member;
wherein said transmitter member is located within said interior volume, is connected to said power member, and is adapted to send electronic signals to said external source;
a computer member;
wherein said computer member is located within said interior volume, is electrically connected to said receiver member and said transmitter member, is adapted to receive power from said power member, and is adapted to send electronic signals to each said mechanical device of each of said plurality of modules;
a front surface;
a plurality of control members;
wherein said plurality of control members are located upon said front surface and are electrically connected to said power member and said computer member;
wherein said control panel is adapted to be electronically and releasably attached to said base station and control the functions of said base station, and each of said plurality of modules.

2. The pet servicing device of claim 1, wherein said base portion and said plurality of modules are disc-shaped; and wherein each of said plurality of modules includes a motor member therein electrically connected to a respective said power member and are adapted to allow said computer member of said control panel to rotate each of said plurality of modules to a chosen position.

3. The pet servicing device of claim 1, wherein said front surface of said control panel further includes a video screen connected thereto electrically connected to said power member and said computer member.

4. The pet servicing device of claim 1, wherein said front surface of said control panel further includes at least one speaker member connected thereto electrically connected to said power member and said computer member.

5. The pet servicing device of claim 1, wherein said front surface of said control panel further includes at least one microphone member connected thereto electrically connected to said power member and said computer member.

6. The pet servicing device of claim 1, wherein said front surface of said control panel further includes at least one camera member connected thereto electrically connected to said power member and said computer member.

7. The pet servicing device of claim 1, wherein said front surface of said control panel further includes at least one USB connector port connected thereto electrically connected to said power member and said computer member.

8. The pet servicing device of claim 1, further comprising a disc member adapted to be bit and chewed by an animal; wherein said mechanical device of one of said plurality of modules is formed as a disc thrower; and wherein said one of said plurality of modules includes a motor member therein electrically connected to said power member and adapted to allow said computer member of said control panel to rotate said one of said plurality of modules to a chosen position to throw said disc member.

9. The pet servicing device of claim 1, further comprising a ball member adapted to be bit and chewed by an animal; wherein said mechanical device of one of said plurality of modules is formed as a ball thrower; and wherein said one of said plurality of modules includes a motor member therein electrically connected to said power member and adapted to allow said computer member of said control panel to rotate said one of said plurality of modules to a chosen position to throw said ball member.

10. The pet servicing device of claim 1, wherein said at least one mechanical device is a treat dispenser.

11. The pet servicing device of claim 1, wherein said at least one mechanical device includes a food bowl and a water bowl.

12. The pet servicing device of claim 1, wherein said at least one mechanical device includes a laser pointer; and wherein said one of said plurality of modules includes a motor member therein electrically connected to said power member and adapted to allow said computer member of said control panel to rotate said one of said plurality of modules to a chosen position to point said laser pointer.

13. The pet servicing device of claim 1, wherein said at least one mechanical device is a robotic arm; and wherein said one of said plurality of modules includes a motor member therein electrically connected to said power member and adapted to allow said computer member of said control panel to rotate said one of said plurality of modules to a chosen position to operate said robotic arm.

14. The pet servicing device of claim 1, wherein said power source is formed as a power cord adapted to be plugged into an external power source.

15. The pet servicing device of claim 1, wherein one of said plurality of modules is formed as a storage chamber.

16. The pet servicing device of claim 2, wherein said control panel is formed having an arcuate cross-section adapted to partially wrap around adjacent outer edges of said plurality of modules when located upon said elongated spindle member.

17. The pet servicing device of claim 1, wherein said receiver member and said transmitter member of said control panel incorporates BLUETOOTH technology.

18. The pet servicing device of claim 4, wherein said speaker member is adapted to emit high-frequency sounds adapted to attract the attention of an animal.

19. The pet servicing device of claim 1, further comprising an external device adapted to communicate with said receiver member and said transmitter member of said control panel, and adapted to control said pet servicing device.

20. The pet servicing device of claim 1, wherein said external device is formed as a smart phone.
